(19) United States
(12) Patent Application Publication
(10) Pub. No.: US 2011/0242476 A1
(43) Pub. Date: Oct. 6, 2011

(54) LIQUID CRYSTAL DISPLAY PANEL AND LIQUID CRYSTAL DISPLAY

(75) Inventors: Hiroyuki Moriwaki, Osaka (JP); Keiichi Fukuyama, Osaka (JP)

(73) Assignee: SHARP KABUSHIKI KAISHA, Osaka (JP)

(21) Appl. No.: 13/139,506

(22) PCT Filed: Jul. 24, 2009
(86) PCT No.: PCT/JP2009/063292

§ 371 Date: Jun. 13, 2011

(30) Foreign Application Priority Data
Dec. 16, 2008 (JP) 2008-320129

(51) Int. Cl. G02F 1/1339

(52) U.S. Cl. 349/153

(57) ABSTRACT

Provided are a liquid crystal display panel in which the distance between substrates is maintained consistent inside and outside the sealing member border, which prevents cell thickness irregularity and ensures uniform display quality over the entire display region, and a liquid crystal display device including such a liquid crystal display panel. In the liquid crystal display panel, a thin film transistor substrate and an opposite substrate facing the thin film transistor substrate are bonded together with a sealing member, a liquid crystal layer is held inside the region bordered by the sealing member, and spacers are disposed inside and outside the region bordered by the sealing member. In the thin film transistor substrate, the thickness of the panel-constituting members disposed in regions overlapping the spacers is substantially the same inside and outside the region bordered by the sealing member.

### TECHNICAL FIELD

The present invention relates to a liquid crystal display panel and a liquid crystal display device. More particularly, the present invention relates to a liquid crystal display panel and a liquid crystal display device that can suitably be used for a liquid crystal display device in which external members are mounted in the external connection terminal section.

### BACKGROUND ART

In the information-intensive society of recent years, demands for display devices such as liquid crystal display devices and organic electroluminescence display devices are on the rise, and those displays are used in a wide variety of fields. Among such display devices, liquid crystal display devices are thin and feature low power consumption, and therefore are in wide use for office automation devices such as personal computers, mobile information terminal devices such as electronic organizer and portable phones, and monitors for camera-integrated VTR. Liquid crystal display devices are under further development to meet demands in various aspects of the information society.

Liquid crystal display panels normally have a structure in which two substrate are bonded together with a sealing member. For a high display quality, it is important to maintain the cell thickness in the display region constant. Therefore, generally, spacers are disposed in the display region to control the cell thickness, but there still was a room for improvement for higher display quality.

In the liquid crystal display panel, terminals are provided for external connection on one of the substrates, and external members are connected to the terminals via anisotropic conductive films. Examples of external members are flexible printed circuits (FPC) and COG (Chip on Glass).

For example, as shown in FIG. 11, a conventional liquid crystal display device includes, in the display region on a substrate 520, thin film transistors that include a source electrode 511, a drain electrode 512, a gate electrode 513, an amorphous silicon film 514, an ohmic contact layer 515, and a gate insulating film 516, and further includes an organic insulating film 519 and a reflective electrode 517 on the thin film transistors. Also, as shown in FIG. 12, in the peripheral region in which external members such as COGs are connected to the terminals, an opening portion was formed in the organic insulating film 519, and a pad 518 composed of conductive films 518a, 518b, and 518c was formed in the opening portion. The pad 518 and a bump 522 of the COG were connected via conductive particles 521 contained in an anisotropic conductive film. In such configuration, due to the difference in level between the pad 518 portion and the organic insulating film 516, the pad 518 and the bump 522 did not link to each other inside the opening portion. Consequently, defects were likely to occur, and therefore, there was a chance that liquid crystal display device could stop operating or could malfunction.

In order to prevent such problems, a technology was disclosed (see Patent Document 1, for example) in which pixels including a thin film transistor as switching elements are formed in an device region, which is the central portion of the substrate; a gate input pad and a data input pad are formed in a pad region, which is the margin area of the substrate; an organic insulating film is formed over the entire substrate on which thin film transistors and the pads are formed; the organic insulating film is subject to exposure and development to create a structure of recesses and protrusions in the top portion of the organic insulating film, which is for forming curvature in the reflective electrode; and an organic insulating film is formed over the top surface of the pad and the area adjacent to the pad in such manner as to make this area more level than other areas.

Another technology was disclosed (see Patent Document 2, for example), in which a substrate of a liquid crystal display device has signal lines, which extend from a display region to a non-display region; a plurality of terminals are provided on an end portion of the substrate for electrically connecting external circuits to the display region circuits; a protective film is provided to cover the terminals; pads to be connected to the terminals are provided on the protective film; each of the plurality of pads has a contact region and a flat contiguous region, and the pads are in contact with the corresponding terminals formed below through pad contact holes formed in the protective film in the contact region; each of the pads is electrically connected to an external circuit terminal by pressure bonding via an anisotropic conductive resin in the flat contiguous region.

### RELATED ART DOCUMENTS

### Patent Documents

Patent Document 1: Japanese Patent Laid-Open Publication No. 2002-229058 (pages 1 to 2)

Patent Document 2: Japanese Patent Laid-Open Publication No. 2002-244151 (pages 1 to 2)

### SUMMARY OF THE INVENTION

### Problems to be Solved by the Invention

The present invention was devised in consideration of the current situation described above, and is aimed at providing a liquid crystal display panel in which the cell thickness irregularity can be suppressed and the display uniformity over the entire display region can be achieved, and a liquid crystal display device that includes such display panel.

### Means for Solving the Problems

In the course of investigating various technologies to suppress the cell thickness irregularity of the liquid crystal display device and to improve the display quality, the inventors of the present invention came to focus on the distances between the substrates (the distance between the pair of substrates) inside and outside the area bounded by the sealing member. The inventors considered providing spacers in both the display region and the region in which pads (external connection terminals) are disposed (i.e., terminal region). However, as described above, in a configuration in which the organic insulating film is removed to eliminate the level difference in the area around of the external connection terminals, the height of the members constituting the liquid crystal display panel (panel-constituting member) inside the sealing member border is different from that outside the sealing member border. Also, the heights of the panel-constituting members in the terminal region are different from the heights of the panel-constituting members in the display region. As a result, the distances between the substrates were different in a region inside the sealing member and outside of it, which can cause display irregularity. The inventors then found that, in a liquid crystal display panel, by placing spacers inside and outside the sealing member and by making the thickness of the panel-constituting members of the thin film transistor substrate in regions overlapping the spacers substantially equal between inside and outside the sealing member, display irregularity due to the cell thickness irregularity can be suppressed and a uniform display over the entire display region can be obtained. As a result, the above-mentioned problems have been admirably solved, leading to completion of the present invention.

That is, the present invention is a liquid crystal display panel in which a thin film transistor substrate and an opposite substrate that faces it (thin film transistor substrate) are bonded together with a sealing member, and a liquid crystal layer is held inside the region bounded by the sealing member, wherein the liquid crystal display panel has spacers disposed thereon inside and outside the sealing member, and the thicknesses of the panel-constituting members of the thin film transistor substrate in regions overlapping the spacers are substantially equal between inside and outside the sealing member.

The present invention is described in detail below.

A liquid crystal display panel of the present invention is composed of a thin film transistor (TFT) substrate and an opposite substrate facing the TFT substrate, which are bonded together with a sealing member, and a liquid crystal layer is held within the region bounded by the sealing member. The TFT substrate is a glass substrate having panel-constituting members such as TFTs and external connection terminals. A preferred configuration of the TFT substrate includes, for example, a display region inside the sealing member, and a terminal region outside the sealing member in which external connection terminals are provided. The opposite substrate is preferably a color filter (CF) substrate, which is, for example, a glass substrate having a color filter and the like disposed thereon. The substrates, however, are not limited to such.

The sealing member is disposed to surround the display region, and it is normally disposed along the outer edge portions of the TFT substrate and the opposite substrate for bonding the two substrates together. The pair of substrates that are bonded together with the sealing member has a liquid crystal material sealed in between the substrates to form a display region inside the sealing member.

The aforementioned liquid crystal display panel has spacers disposed inside and outside the region bounded by the sealing member. That is, the spacers are disposed both in a region bounded by the sealing member and outside the sealing member. The spacers are used to maintain a uniform distance between pairing substrates (inter-substrate distance). Types of the spacers are not particularly limited. The spacers can be particle-shaped spacers such as beads, or column-shaped spacers. The column-shaped spacers are formed by patterning a resin such as curable resin. In particular, photo spacers made of photocurable resin and spacer beads are preferably used. The spacer may be provided on the TFT substrate or on the opposite substrate. The height (thickness) of the spacer is not particularly limited. However, the spacers are normally used to make the thickness of a liquid crystal layer uniform. For that reason, preferably the height of the spacers is normally about the same as the thickness of the liquid crystal layer. The area of the spacers when observed in a plan view can be adjusted as appropriate depending on the size of the liquid crystal display panel and the pixel size, but preferably the area is 10 to 5000 μm².

The TFT substrate has panel-constituting members disposed inside and outside the region bounded by the sealing member. That is, the panel-constituting members are disposed both in the region bounded by the sealing member and outside the sealing member. Configurations of the panel-constituting members are not particularly limited, and various configurations are applicable. Panel-constituting members that can be disposed inside the region bounded by the sealing member include members formed on the substrate (a glass substrate, for example), such as a gate electrode, a source electrode, a drain electrode, a gate insulating film, a TFT composed of semiconductor layers and the like, a planarizing film, an interlayer film, a pixel electrode, an auxiliary capacitance electrode, an alignment film, and the like. Panel-constituting members outside the region bounded by the sealing member can be, for example, external connection terminals for transmitting external signals, a wiring for transmitting signals to the external connection terminals, and a planarizing film. In the case of full-monolithic liquid crystal display devices on which circuits such as pixel driving circuits are mounted, members constituting various circuits such as driver circuit, power supply circuit, and electrostatic discharge (ESD) protection circuit are the panel-constituting members. In this specification, “panel-constituting members” refers to a group of members that are provided on the TFT substrate and constitute a liquid crystal display panel.

In the aforementioned thin film transistor substrate, the thickness of the panel-constituting members disposed in regions overlapping the spacers is substantially equal between inside and outside the region bounded by the sealing member. In this configuration, the height of the panel-constituting members disposed in regions overlapping the spacers from the substrate such as a glass substrate is substantially equal inside and outside the region bounded by the sealing member. As a result, the distance between the substrates can be made substantially equal inside and outside the sealing member. That is, a uniform distance between the substrates can be obtained across the inside and outside the sealing member. Consequently, thickness irregularity of the liquid crystal layer can be suppressed from occurring, and the display quality can be improved. For example, if the inter-substrate distance inside the sealing member (the display region, for example) is different from that outside the sealing member (the terminal region, for example), stress is generated when the substrates are bonded together due to the difference in the inter-substrate distance, which can lead to cell thickness irregularity near the sealing member in the terminal region and display quality deterioration.

“Substantially equal” means that the distance is equal enough to suppress the cell thickness irregularity and to sufficiently improve the display quality, and includes, for example, the case in which the thickness of the panel-constituting members in regions overlapping the spacers disposed outside the sealing member (terminal region, for example) is within ±15%, i.e., 85 to 115% of the thickness in the regions overlapping the spacers disposed inside the sealing member. Difference up to this level is good enough to sufficiently suppress the display irregularity caused by the difference in inter-layer substrate distance, and to improve the display quality of a liquid crystal display panel. The thickness of the panel-constituting members in regions overlapping the spacers may partially be unequal between inside and outside the sealing member. For example, when a plurality of spacers are disposed both inside and outside the region bordered by the sealing member, possible configurations of the liquid crystal display panel of the present invention include the one in which the thickness of the panel-constituting members in a region overlapping at least one of the spacers disposed inside the sealing member is substantially equal to the thickness of the panel-constituting members in a region overlapping at least one of the spacers disposed outside the sealing member.

The configuration of the liquid crystal display panel of the present invention is not particularly limited. As long as the liquid crystal display is formed to include those constituting elements as essential components, other constituting elements can only optionally be included. For example, the total height of the members disposed on the opposite substrate (a color filter substrate, for example) is preferably substantially equal inside and outside the region bordered by the sealing member. Also, in the case of a transmissive reflective liquid crystal display device, which includes a reflective display region, the reflective display region may have a reflective film disposed therein, and also may have a member for adjusting the thickness of the liquid crystal layer in the reflective display region (white color filter, for example) to about ½ of the thickness of the liquid crystal layer in the transmissive display region.

Preferred configurations of the liquid crystal display panel of the present invention are described in detail below. The configurations shown below may be combined as appropriate.

Preferably, the aforementioned thin film transistor substrate has a structure in which external connection terminals are provided outside the region bordered by the sealing member; a planarizing film is disposed in the regions overlapping the spacers inside and outside the region bordered by the sealing member; and the planarizing film is removed for at least part of the region in which the external connection terminals are disposed. For example, the planarizing film in the terminal region of the TFT substrate is removed for at least part of the region where the external connection terminals connected to FPC, COG, or the like are disposed, and is preserved in a region where the external connection terminals are not present. By placing spacers in the region where the planarizing film is preserved, a uniform inter-substrate distance can be obtained. Here, even in a configuration where the planarizing film is partially removed outside the region bordered by the sealing member, the thickness of the panel-constituting members is substantially equal inside and outside the region bordered by the sealing member in the region where spacers are disposed. As a result, occurrence of cell thickness irregularity can be suppressed and the display quality can be improved.

The aforementioned planarizing film is normally formed thicker than other members that constitute the panel-constituting members (constituting members of TFT, for example). Therefore, if the planarizing film is not present in the region overlapping the spacer disposed outside the region bordered by the sealing member, the thickness of the panel-constituting members (the height from the glass substrate or the like) inside the sealing member will be significantly different from that of the outside the sealing member, leading to a significant difference in the inter-substrate distance across the inside and outside of the sealing member. As a result, cell thickness becomes irregular and the display quality can be deteriorated.

Instead of the planarizing film, other members may be disposed in the regions overlapping the spacers. However, in order to form a film having about the same thickness as the planarizing film, the number of manufacturing steps increases, which may lower the productivity.

The planarizing film is preferably a film disposed immediately under the pixel electrode. For example, if the structure immediately under the pixel electrode has significantly uneven surface, the pixel electrode, which is formed immediately over the uneven surface, can have a shape that reflects the surface unevenness. In that case, the thickness of the liquid crystal layer varies due to the uneven surface of the pixel electrode, and that can lead to deterioration of display quality. By disposing the planarizing film immediately under the pixel electrode, the pixel electrode can be made flat and display quality can be improved. In this specification, “disposed immediately under the pixel electrode” means that being disposed in contact with at least a portion of the bottom surface of the pixel electrode.

The planarizing film is a film disposed to make the thickness of the panel-constituting members uniform. Materials for the planarizing film are not particularly limited. They can be, for example, an organic insulating film made of organic insulating material, or a SOG (spin on glass) film formed of methylpolysiloxane (MSQ) based material. These materials can also be layered for use. By using a planarizing film, even if members disposed under the planarizing film have uneven surfaces, the top surface of the planarizing film can be flat.

The planarizing film is preferably at least 0.5 μm thick. Normally, when semiconductor devices such as TFT are formed on the TFT substrate, the surface of the devices can have unevenness of about 0.5 μm. When compensating for the surface unevenness using a planarizing film, the planarizing film preferably has a thickness of at least 0.5 μm. Also, the planarizing film preferably has a thickness of no more than 4 μm. If the film has a thickness of more than 4 μm, contact holes formed in the film, for example, can have an enlarged area, and longer time may be required for the etching. Also, if the planarizing film is thicker than 4 μm, and the planarizing film is formed of a photosensitive material, the film may not be applied evenly, and may not be exposed sufficiently.

The edges of the external connection terminals are preferably disposed immediately under the planarizing film. Aluminum is generally one of the conductive materials used for the external connection terminals, but aluminum can be corroded by moisture and oxygen when exposed to the air. Also, when a pixel electrode formed of indium tin oxide is etched, for example, if aluminum portion is exposed, electric corrosion may occur. Therefore, if an external connection terminal includes an aluminum film, preferably a corrosion-inhibiting conductive film (a titanium film, for example) is disposed on the aluminum film so that the aluminum film is not exposed to the air. However, if a conductive film on the aluminum film and the aluminum film are patterned by the same etching, even though the top surface of the aluminum film is covered by a corrosion-resistant conductive film, the aluminum becomes exposed on the side edges of the aluminum film. One possible way to address this issue is to further form a conductive film (a transparent conductive film or the like, for example, that constitutes the pixel electrode) by patterning to cover the exposed sides of the aluminum film and the conductive film disposed on the top surface of the aluminum film, and to use this as an external connection terminal. However, because the transparent conductive film is normally more resistive than conductive films such as titanium films, external connection terminals with a transparent conductive film disposed thereon can have a high contact resistance when connected to external members.

On the other hand, in a configuration in which the edges of the external connection terminals are disposed immediately under the planarizing film, that is, the edges of the external connection terminals are covered with a planarizing film, the corrosion-prone conductive film can be suppressed from being exposed at the edges of the external connection terminals, and corrosion of the external connection terminals can be suppressed. Such configuration is particularly preferable when the external connection terminals include a corrosion-prone conductive film such as aluminum. More specifically, the configuration is particularly effective when the external connection terminals include a corrosion-prone conductive film such as aluminum, and a corrosion-resistant conductive film such as a titanium film or a titanium alloy film such as titanium nitride; the top surface of the corrosive-prone conductive film is covered with a corrosion-resistant conductive film; and sides of the corrosion-prone conductive film are not covered with a corrosive-resistant conductive film.

The external connection terminals preferably do not include a transparent conductive film. More specifically, the external connection terminals preferably have a configuration in which a transparent conductive film does not cover other conductive film. As described above, by placing the edges of a corrosion-prone conductive film such as an aluminum film immediately under the planarizing film, corrosion can be suppressed without providing a transparent conductive film. Also, normally, a transparent conductive film is more resistive than a metal film. As a result, if a transparent conductive film is used as a conductive film that constitutes the surface of the external connection terminal, the contact resistance increases. On the other hand, in a configuration in which the top layer of the external connection terminal is not covered by a transparent conductive film, the contact resistance can be lowered. The transparent conductive film is not particularly limited, and it can be, for example, an indium tin oxide film or indium zinc oxide film.

A preferred configuration of the thin film transistor substrate has a multi-layered wiring structure in which a first conductive film, a first planarizing film, a second conductive film, and a second planarizing film are arranged in this order inside the region bordered by the sealing member, and the external connection terminals do not include a conductive film that is formed in the manufacturing step of forming the second conductive film. For example, for a conductive film constituting the second conductive film, a multi-layered film having a structure of molybdenum film/aluminum film or the like is preferably used. However, if the film disposed as the top layer is a molybdenum film or the like, which is less water-resistant and more corrosion-prone than a titanium film or the like, and if the molybdenum film is used to form an external connection terminals, the reliability may be deteriorated due to corrosion or the like. Therefore, by not including, in the external connection terminals, the conductive film that is formed in the process in which the second conductive film is formed, the properties deterioration of the external connection terminals can be suppressed even if a relatively corrosion-prone metal material is used as the second conductive film, and the reliability of the external connection terminals can be improved. Here, a “conductive film that is formed in the process in which the second conductive film is formed” refers to a conductive film formed in the same depositing and patterning processes as the second conductive film, and preferably a conductive film formed in the same vapor deposition and patterning processes as the second conductive film.

In the case that the thin film transistor substrate has the multi-layered wiring structure, by using the first conductive film and the second conductive film as wirings, for example, a portion of the first conductive film and a portion of the second conductive film can be disposed so that they overlap one another through the first planarizing film. As a result, the region in which the wirings are disposed can be made small. For example, the first conductive film can be used as a local wiring (locally formed wiring) such as the source wiring and the drain wiring in a thin film transistor in the circuit. The second conductive film can be used as, for example, a power supply wiring for a driver, a power supply circuit, and the like, or as a common wiring of signal wirings, and the like.

Also, the top layer of the first conductive film may be a titanium film, and a conductive film formed in the same process as the first conductive film may be used as the external connection terminals, and, furthermore, the second conductive film does not need to be used as a film that constitutes the external connection terminals. With this configuration, when a multi-layered wiring structure is formed by wet etching, the titanium film, which is the top layer of the first conductive film, can be used as an etching stopper. In this case, even if the first conductive film contains an aluminum film, because the aluminum at the edges of the first conductive film are normally disposed under the first planarizing film, the aluminum can be prevented from being etched at the time of wet etching.

A preferred configuration of the thin film transistor substrate is a multi-layered wiring structure in which a first conductive film, a first planarizing film, a second conductive film, and a second planarizing film are arranged in this order inside the region bordered by the sealing member, and the external connection terminal does not include the conductive film that is formed in the process in which the first conductive film is formed. For example, in the case that a relatively corrosion-prone metal material is used as the material of the first conductive film material, and a corrosion-resistant metal material is used as the material of the second conductive film, by not including in the external connection terminals the conductive film formed in the process in which the first conductive film is formed, corrosion in the external connection terminals can be suppressed.

The external connection terminals are terminals used to transmit the power and/or signals from an external source (an external member such as FPC) to the wirings provided on the thin film transistor substrate, or terminals used to transmit signals from the thin film transistor substrate to outside, and they are conductive. The configuration of the external connection terminal is not particularly limited. The external connection terminals may be, for example, a single-layer film made of a single-layer conductive film, a multi-layered film composed of a plurality of conductive films, or the like.

The external connection terminals are to be provided in a terminal region, which is outside the region bordered by the sealing member, and a planarizing film is to be provided in the terminal region. Because the external connection terminals are for connection to external members, the thin film transistor substrate preferably has a configuration in which a planarizing film is disposed to prevent contact failure between the external connection terminals and the external members due to the uneven surface level around the external connection terminals. To obtain such configuration, in the proximity of the external connection terminals (the region where the external connection terminals are disposed and the area around the terminals), for example, the planarizing film preferably has its portion removed in an amount that is at least 10% larger than the area of the external member terminals such as COG bumps and FPC external connection wirings (the area when observed in a plan view), and more preferably, the planarizing film has its portion removed in an amount that is at least 20% larger than the area of the external member terminals. With this configuration, contact failure between the external connection terminal and the external members can be suppressed from occurring. That is, the connection stability between them and the production yield can be improved, and a highly reliable liquid crystal display device can be provided.

Preferably the external connection terminals are connected to external members via an anisotropic conductive film. The anisotropic conductive film is a film that is conductive in the out-of-plane direction (the normal direction to the substrate plane), but not conductive in the in-plane direction (in the direction of the substrate plane). Through the anisotropic conductive film, each of the terminals of external members and each of the external connection terminals can be matched up one-to-one to establish electrical connections. Also, the anisotropic conductive film is preferably adhesive so that the external connection terminals are physically bonded to external members. A preferable anisotropic conductive film includes conductive particles contained in the insulating material for connecting the external connection terminals and external members together. The shape of the conductive particles is not particularly limited. The particle shape may be cubic or octahedral, but a spherical shape is preferable.

External members to be connected to the anisotropic conductive film are not particularly limited. They may be electronic components such as resistors, capacitors, coils, connectors, diodes, and transistors; flexible printed circuits (FPC), and chips (COG: Chip On Glass) or resin films (COF: Chip On film) with an integrated circuit (IC) including circuit elements and wirings formed thereon. Other external members include printed wiring boards (PWB), printed circuit boards (PCB), and tape carrier packages (TCP). Such external members are electrically connected to the external connection terminals through anisotropic conductive films. The external members preferably have conductive protrusions in the region overlapping the external connection terminals. Such conductive protrusions are also called “external connection wirings” or “bumps.” The conductive protrusions are to be connected to the external connection terminals via conductive particles in the anisotropic conductive film.

The present invention is also a liquid crystal display device including the aforementioned liquid crystal display panel. As described above, a liquid crystal display device with high display quality can be provided by including a liquid crystal display panel capable of suppressing the occurrence of cell thickness irregularities. A liquid crystal display device is composed of a liquid crystal display panel and members such as polarizing plates mounted thereon.

### Effects of the Invention

According to a liquid crystal display panel of the present invention, cell thickness irregularities can be suppressed and uniform display quality over the entire display region can be obtained. As a result, a liquid crystal display device having a higher display quality can be provided.

### BRIEF DESCRIPTION OF THE DRAWINGS

FIG. 1 is a schematic cross-sectional view of a liquid crystal display panel according to Embodiment 1, illustrating the pixel region, which is inside the region bordered by the sealing member.

FIG. 2 is a schematic cross-sectional view of a liquid crystal display panel according to Embodiment 1, illustrating the terminal region, which is outside the region bordered by the sealing member.

FIG. 3 is a schematic plan view of a liquid crystal display panel according to Embodiment 1.

FIG. 4 is an enlarged schematic plan view illustrating the region bounded by the dotted lines of FIG. 3.

FIG. 5 is a schematic cross-sectional view of a liquid crystal display panel according to Embodiment 1, illustrating the external connection terminals and a flexible printed circuit (FPC) as they are bonded together in the terminal region of a TFT substrate by an anisotropic conductive film.

FIG. 6 is a schematic cross-sectional view of a liquid crystal display panel according to Embodiment 2, illustrating the terminal region, which is outside the region bordered by the sealing member.

FIG. 7 is a schematic cross-sectional view of a liquid crystal display panel according to Embodiment 3, illustrating the pixel region, which is inside the region bordered by the sealing member

FIG. 8 is a schematic cross-sectional view of a liquid crystal display panel according to Embodiment 3, illustrating the terminal region, which is outside the region bordered by the sealing member.

FIG. 9 is a schematic cross-sectional view of a liquid crystal display panel according to Comparison Example 1, illustrating the terminal region that is outside the region bordered by the sealing member.

FIG. 10 is a schematic cross-sectional view of a liquid crystal display panel according to Comparison Example 1, illustrating the external connection terminal and a flexible printed circuit (FPC) as they are bonded together in the terminal region of a TFT substrate through an anisotropic conductive film.

FIG. 11 is a schematic cross-sectional view, illustrating the pixel region of a conventional liquid crystal display panel.

FIG. 12 is a schematic cross-sectional view, illustrating the terminal region of a conventional liquid crystal display panel.

### DETAILED DESCRIPTION OF EMBODIMENTS

Below, embodiments of the present invention are enumerated and described further in detail with reference to figures. The present invention, however, is not limited to these embodiments.

### Embodiment 1

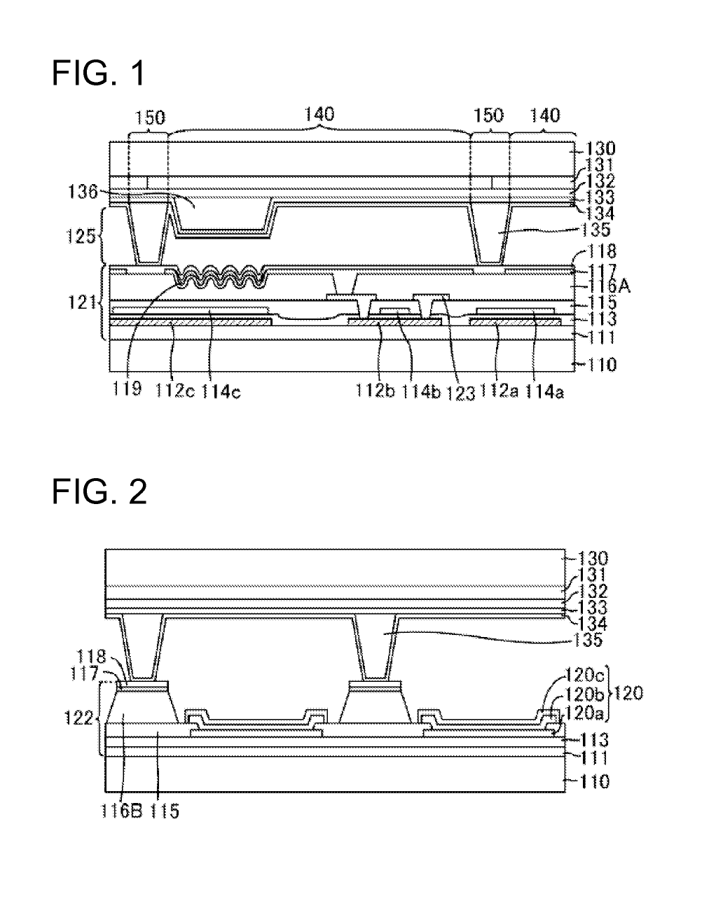

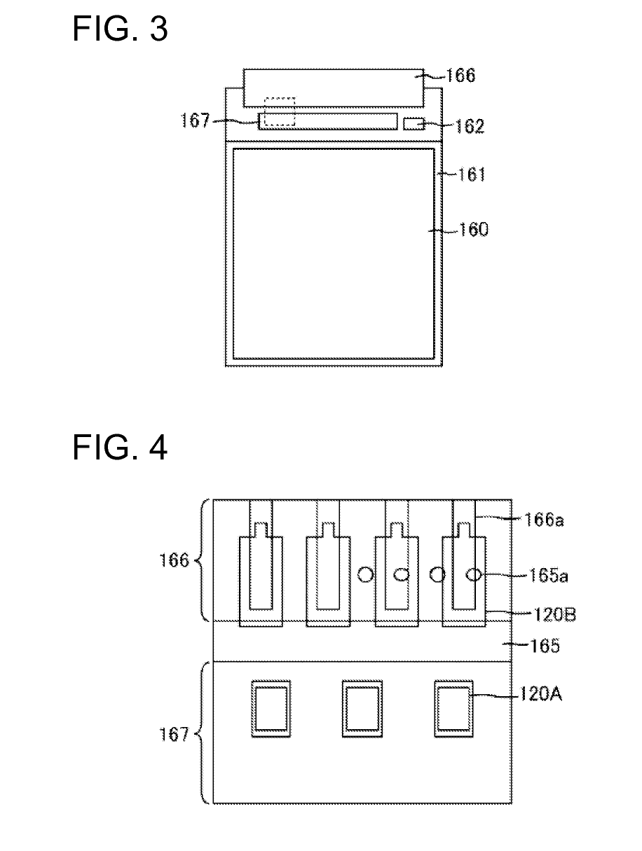

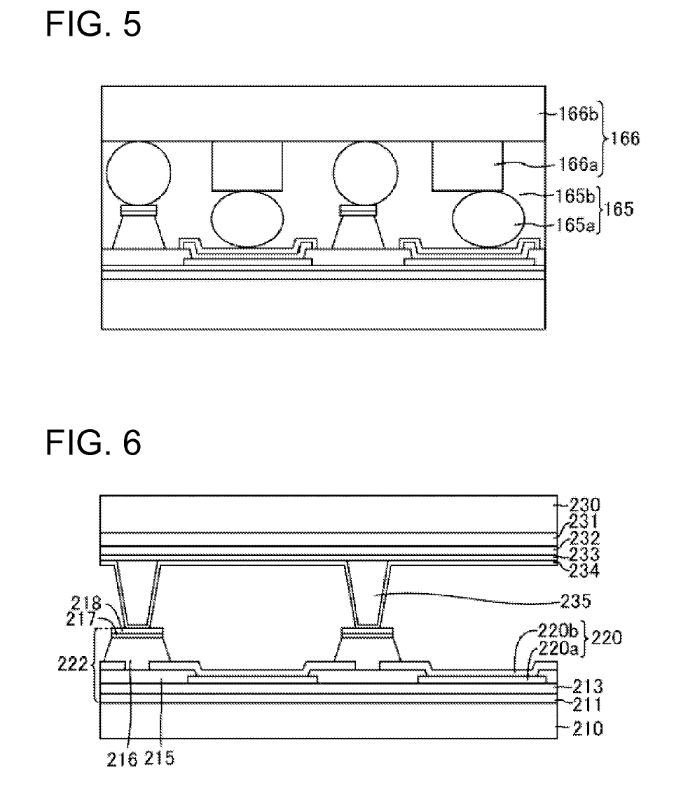

FIG. 1 is a schematic cross-sectional view of a liquid crystal display panel according to Embodiment 1, illustrating the pixel region, which is inside the region bordered by the sealing member. FIG. 2 is a schematic cross-sectional view of a liquid crystal display panel according to Embodiment 1, illustrating the terminal region, which is inside the region bordered by the sealing member. FIG. 3 is a schematic plan view of a liquid crystal display panel according to Embodiment 1, and FIG. 4 is an enlarged schematic plan view of the region bordered by dotted lines in FIG. 3. FIG. 5 is a schematic cross-sectional view of a liquid crystal display panel according to Embodiment 1, illustrating the external connection terminal and the flexible printed circuit (FPC) as they are bonded together in the terminal region of a TFT substrate through an anisotropic conductive film. A liquid crystal display panel according to Embodiment 1 has a structure in which a TFT substrate with TFTs, pixel electrodes, and the like provided thereon, and a color filter substrate with a color filter and the like provided thereon are bonded together by a sealing member.

Normally, when liquid crystal display panels are manufactured, members for forming a plurality of liquid crystal display panels are disposed on one large glass substrate, and two of such large glass substrates (for example, a large glass substrate with members that constitute a plurality of TFT substrates disposed thereon, and another large glass substrate with members that constitute a plurality of color filter substrates disposed thereon) are bonded together by a sealing member, and then liquid crystal display panels are individually separated.

FIGS. 1 and 2 are schematic cross-sectional view of large glass substrates before individual liquid crystal display panels are separated, and FIGS. 3 to 5 are schematic cross-sectional views or plan views of the large glass substrates after individual liquid crystal display panels are separated.

First, the configuration of the TFT substrate in the display region is described. As shown in FIG. 1, on the substrate 110, a base layer 111 is provided in which a silicon oxide nitride film having a thickness of 50 nm and a TEOS film (silicon oxide film) having a thickness of 100 nm are layered, and on the base layer 111, island-shaped semiconductor layers 112a, 112b, and 112c are disposed. Over the base layer 111 and the semiconductor layers 112a, 112b, and 112c, a first insulating film 113 that will become a gate insulating film is provided. Over the first insulating film 113, a gate wiring 114b and auxiliary capacitance electrodes 114a and 114c are disposed. The auxiliary capacitance electrodes 114a and 114c are arranged to overlap the semiconductor layers 112a and 112c, respectively, to form auxiliary capacitances. Over the gate wiring 114b and the auxiliary capacitance electrodes 114a and 114c, a cap film made of TEOS, and a multi-layered interlayer film 115 in which a SiNx film and a TEOS film are layered are formed. Over the multi-layered interlayer film 115, source and drain wirings 123 are formed. The source and drain wirings 123 have a multi-layered structure in which a titanium film having a thickness of 100 nm, an aluminum film having a thickness of 350 nm, and a titanium film having a thickness of 100 nm are layered in this order. The source and drain wirings 123 are connected to the semiconductor layer 112b through contact holes formed in the first insulating film 113 and in the multi-layered interlayer film 115. This configuration forms a TFT that will become a switching element of a pixel. Over the source and drain wirings 123, a planarizing film 116A is formed, which is an organic insulating film. Over the planarizing film 116A, a transparent conductive film 117 made of indium tin oxide is disposed. The transparent conductive film 117 is connected to the drain side of the source and drain wirings 123 via a contact hole formed in the planarizing film 116A. The transparent conductive film 117 functions as a pixel electrode in the display region. Also, a part of the planarizing film 116A in the pixel region 140 has a rough surface. In the region where the rough surface is formed, a reflective film 119 is provided in which a molybdenum film having a thickness of 50 nm, an aluminum film having a thickness of 100 nm, and an indium zinc oxide film having a thickness of 30 nm are layered. The region in a pixel region 140 where the reflective film 119 is disposed functions as the reflective display region, and the region in the pixel region 140 where the reflective film 119 is not disposed functions as a transmissive display region. An alignment film 118 is disposed over the reflective film 119 and the transparent conductive film 117.

Next, the color filter substrate that faces the TFT substrate is described. In the display region of the color filter substrate, a color filter 131 is disposed on a substrate 130. On the color filter 131, an overcoat layer 132 is disposed. In the reflective display region (the region that faces the region where the reflective film 119 is disposed) on the overcoat layer 132, a white color filter 136 having a thickness of 2 μm is disposed. On the overcoat layer 132 and the white color filter 136, a common electrode 133 formed of indium tin oxide is disposed to cover the entire substrate. In the boundary regions 150 on the common electrode 133 (boundary regions between adjacent pixels), photo spacers 135 having a height of 4 μm are disposed. Over the common electrode 133 and the photo spacers 135, an alignment film 134 is disposed. In the boundary regions 150, the photo spacers 135 are in contact with an alignment film 118 through the alignment film 134.

Next, the structure of the TFT substrate in the terminal region is described. FIG. 2 is a schematic cross-sectional view of a liquid crystal display panel according to Embodiment 1, illustrating the terminal region, which is outside the region bordered by the sealing member. FIG. 2 shows a large glass substrate before it is separated into individual liquid crystal display panels. FIG. 2 also shows the color filter substrate and the TFT substrate as they face each other in the external connection terminal section.

As shown in FIG. 2, over the substrate 110 in the terminal region, a base layer 111 and a first insulating film 113 are disposed in this order, as in the display region. On the first insulating film 113, a conductive film 120a, which was patterned in the same manufacturing step as the gate wiring 114b, is disposed. Over the conductive film 120a, a multi-layered film 120b, which was patterned in the same manufacturing step as the source and drain wirings 123, is disposed. Over the conductive film 120b, a transparent conductive film 120c, which was patterned in the same manufacturing step as the transparent conductive film 117, is disposed. That is, over the first insulating film 113, external connection terminals 120 in which conductive films 120a, 120b, and 120c are layered are provided. In the regions where the external connection terminal 120 is not present, multi-layered interlayer films 115 are disposed. However, edges of the external connection terminal 120 and edges of the multi-layered interlayer film 115 partially overlap. On the multi-layered interlayer film 115, a planarizing film 116B, which was patterned by exposure and development, is disposed. On (on the top surface of) the planarizing film 116B, a transparent conductive film 117 and an alignment film 118, which were formed by patterning, are layered. The planarizing films 116B are provided around the external connection terminals 120, or more specifically, disposed 5-10 μm away from the edges of the external connection terminals 120. With this configuration, when external members such as COG bumps are connected to the external connection terminals, the planarizing film 116B can further suppress defects such as contact failure from occurring.

In the terminal region of the color filter substrate, as in the display region, a color filter 131, an overcoat layer 132, and a common electrode 133 are disposed in this order on the substrate 130. On the common electrode 133, photo spacers 135 having a height of 4 μm are disposed. Over the common electrode 133 and the photo spacers 135, an alignment film 134 is disposed. The photo spacers 135 are disposed at locations facing the regions where the planarizing film 116B, the transparent conductive film 117, and the alignment film 118, which are patterned so as not to overlap the external connection terminal 120, are disposed in this order. Here, the height of the panel-constituting members 121 from the substrate 110 in the regions facing the spacers 135 in the display region, is substantially the same as the height of the panel-constituting members 122 from the substrate 110 in the regions facing the spacers 135 in the terminal region. This is because the thicknesses of members disposed in layers below the transparent conductive film 117 are averaged out by the presence of the planarizing films 116A and 116B. Such configuration can make the inter-substrate distance consistent between the display region and the terminal region. As a result, cell thickness irregularity can be suppressed in the display region, and a liquid crystal display panel of high display quality can be provided.

From the perspective of making the distance between the substrates more uniform, the transparent conductive film 117 and the alignment film 118 are preferably disposed on the planarizing film 116B in the terminal region. However, the transparent conductive film 117 and the alignment film 118 are thinner compared to the planarizing film 116B. Consequently, the distance between substrates can sufficiently be made uniform without the transparent conductive film 117 or the alignment film 118. Therefore, the transparent conductive film 117 and the alignment film 118 may not need to be disposed on the planarizing film 116B.

As shown in FIG. 3, a liquid crystal display panel according to Embodiment 1, after being separated from the large glass substrate, has a sealing member 161 bordering the display region 160. The sealing member 161 is disposed between the TFT substrate and the color filter substrate. In the terminal region, which is outside the region bordered by the sealing member 161, an electronic component 162 such as a capacitor, a flexible printed circuit (FPC) 166, a chip (COG: Chip On Glass) 167 on which an integrated circuit (IC) including circuit elements and wirings are formed, are arranged. In the region bounded by dotted lines in FIG. 3, as shown in FIG. 4, external connection terminals 120A for connection to banks of COG 167, and external connection terminals 120B for connection to external connection wiring 166a of FPC 166 are provided as external connection terminals 120. The external connection wiring 166a and the external connection terminals 120B are connected via conductive particles 165a in an anisotropic conductive film 165. The COG 164, as in the case of the FPC 166, is connected to the external connection terminals 120A via the anisotropic conductive film 165. Also, as shown in FIG. 5, in the area where the FPC 166 is connected, the planarizing film 116B is removed so that it does not overlap the external connection wiring 166a of FPC 166 and therefore does not cause a contact failure. As a result, contact failures can be suppressed. In the area where the COG 167 is connected, the planarizing film 116B is removed so that it does not overlap the COG 167 bumps and therefore not cause a contact failure. Here, the external connection wiring 166a is formed on the FPC base material 166b, and conductive particles 165a are dispersed in an insulating material 165b.

When the sealing member 161 is printed and the substrates are bonded together, the color filter substrate extends to overlap the external connection terminals 120, which are located outside the sealing member 161. That is, in the terminal region, the color filter substrate and the TFT substrate overlap. Later, when individual liquid crystal display panels are separated from the large glass substrate, the portion of the color filter substrate that faces the external connection terminals 120 is removed (the step of exposing the terminals), and the entire external connection terminals 120 including external connection terminals 120A and 120B is exposed.

FIG. 2 shows the configuration prior to panel separation, illustrating the external connection terminals 120 and the color filter substrate facing each other. In FIGS. 3-5, which show the configuration after the panel separation, the color filter substrate is not present at the location facing the external connection terminals 120. Cell thickness irregularity is caused by any difference in pressure between inside and outside the sealing member 161 when substrates are bonded together, and the difference in pressure results from the difference in density distribution of spacers 135 inside and outside the sealing member 161. Therefore, absence of spacers 135 facing the area around the external connection terminals 120 after the panel separation is not particularly a problem. However, even after the panel separation, there remains an area where the color filter substrate and the TFT substrate face each other near the sealing member 161 outside the sealing member 161 (terminal region), and spacers 135 are disposed in that area. The same holds for liquid crystal display panels according to Embodiments 2 and 3, which are described later.

Below, steps for manufacturing a display device panel according to Embodiment 1 are described.

First, the TFT substrate is described. As a pre-treatment, a substrate 110 is washed and subjected to pre-annealing. The types of the substrate 110 are not particularly limited, but from the perspective of costs and other issues, a glass substrate, resin substrate, and the like are preferred. Subsequently, steps (1)-(10) described below are performed.

(1) Forming a Base Layer

Over the pre-treated substrate 110, a SiON film and a SiOₓ film are deposited by Plasma Enhanced Chemical Vapor Deposition (PECVD) or the like to form a base layer 111. Material gases for formation of a SiON film may be a mixed gas composed of silane (SiH₄), nitrous oxide gas (N₂O), and ammonia (NH₃), or the like. The SiOₓ film is preferably formed using Tetra Ethyl Ortho Silicate (TEOS) gas as a material gas. As the base layer 111, a silicon nitride (SiNₓ) film or the like formed by using, for example, a mixed gas composed of silane (SiH₄) and ammonia (NH₃) may be used instead.

(2) Forming a Semiconductor Layer

An amorphous silicon (a-Si) film is formed by PECVD method. Material gases such as SiH₄, disilane (Si₂H₆), and the like can be used to form the a-Si film. Because hydrogen is contained in the a-Si film formed by PECVD method, a treatment to reduce the hydrogen concentration in the a-Si layer (dehydrogenation treatment) is conducted at about 500° C. Also, after this treatment, a metal catalyst may be applied and then a pre-treatment for making a continuous grain silicon (CG-silicon) may be conducted. Subsequently, laser annealing is conducted to melt, cool down, and solidify the a-Si film to form a p-Si film. For laser annealing, excimer laser, for example, is used. For polysilicon (p-Si) film formation, heat treatment for solid-phase crystallization may be conducted as a pre-treatment for laser annealing. Next, the p-Si film is patterned by dry etching using a carbon tetrafluoride (CF₄) gas to form semiconductor layers 112a, 112b, and 112c. In the semiconductor layers 112a, 112b, and 112c, a source region, drain region, channel region, and the like are formed by ion doping or the like after a first insulating film or a gate wiring is formed, which is described below.

(3) Forming a First Insulating Film (Gate Insulating Film)

Next, using a TEOS gas as a material gas, a first insulating film (gate insulating film) 113 is formed of silicon oxide. The first insulating film (gate insulating film) may be a film formed of other material, such as a SiNₓ film, SiON film, or the like. Material gases for forming SiNₓ and SiON films may be similar to those listed in the description of the base layer formation. The first insulating film 113 can be multi-layered composed of a plurality of materials mentioned above.

(4) Forming a Gate Wiring and a Conductive Film for the External Connection Terminals

Next, a tantalum nitride (TaN) film and a tungsten (W) film are deposited by sputtering. Then, after a resist film is patterned into a desired shape by photolithography, a mixed gas composed of adjusted amounts of argon (Ar), sulfur hexafluoride (SF₆), carbon tetrafluoride (CF₄), oxygen (O₂), chlorine (Cl₂), and the like is used as the etching gas for dry etching to form a gate wiring 114b, and auxiliary capacitance electrodes 114a and 114c. In the terminal region, a conductive film 120a that constitutes the external connection terminals 120 is formed. For gate wiring 114b, auxiliary capacitance electrodes 114a and 114c, and conductive film 120a, metals such as those having low resistivity such as tantalum (Ta), molybdenum (Mo), molybdenum tungsten (MoW), aluminum (Al), and the like, and those with smooth surfaces and high melting points may be used. Also, the gate wiring 114b, the auxiliary capacitance electrodes 114a and 114c, and the conductive film 120a may have a multi-layered structure or the like composed of a plurality of materials listed above.

(5) Forming a Multi-Layered Interlayer Film

Next, over the entire TFT substrate, a cap film made of TEOS, a SiNₓ film, and a TEOS film are deposited by PECVD method to form a multi-layered interlayer film 115. As the multi-layered interlayer film 115, a SiON film or the like may also be used. A cap film is a thin film having a thickness of about 50 nm, and is formed to prevent the transient deterioration and the like, to improve the reliability of TFT properties and to stabilize their electrical properties.

(6) Patterning the Multi-Layered Interlayer Film

Next, after a resist film is patterned into a desired shape by photolithography, the first insulating film 113 and the multi-layered interlayer film 115 are wet-etched using a hydrofluoric acid-based etchant to form contact holes for connecting the source and drain wirings 123 to the semiconductor layer 112b. Also, at the same time, the multi-layered interlayer film 115 is patterned so that the surface of the conductive film 120a is exposed. For the etching, dry etching can be performed instead.

(7) Forming Source and Drain Wirings and a Multi-Layered Film for the External Connection Terminals

Next, a titanium (Ti) film, an aluminum (Al) film, and a Ti film are formed in this order by sputtering or the like. Then, after a resist film is patterned into a desired shape by photolithography, the multi-layered film composed of Ti/Al/Ti metals are patterned by dry etching to form source and drain wirings 123 and a multi-layered film 120b for the external connection terminals 120. Here, the source and drain wirings 123 and the source region or the drain region of the semiconductor layer 112b are connected via contact holes formed in the first insulating film 113 and the multi-layered interlayer film 115. As a metal constituting the source and drain wirings 123 and the multi-layered film 120b, Al—Si alloy or the like may be used instead of Al. Here, although Al is used to lower the resistance of the wiring, the aforementioned materials for the gate wiring (Ta, Mo, MoW, W, TaN, or the like) may be used for a short wiring configuration where high heat resistance is required and an increase in resistance is allowed to a certain extent.

(8) Depositing and Patterning a Planarizing Film

Next, an organic insulating film material, which is a photosensitive resin, is applied over the entire substrate by spin coating or the like. Then, a planarizing film 116 and a contact hole are simultaneously formed through steps of exposure, development, decolorization, and baking. At the same time, the planarizing film 116 is patterned to expose the multi-layered film 120b. As a material for the planarizing film 116, photosensitive acrylic resin, photosensitive epoxy resin, and the like may be used. The planarizing film 116 may also be formed of silicon oxide by PECVD or the like using a TEOS gas as a material gas. From the perspective of productivity, the planarizing film 116 may be formed by spin coating, using a photosensitive or non-photosensitive polyalkylsiloxane-based or polysilazane-based resin. Other materials that can be used for the planarizing film 116 include methylpolysiloxane (MSQ)-based material and porous MSQ-based material.

(9) Forming a Transparent Conductive Film

An ITO film is formed on the planarizing film 116 by sputtering or like method, and patterned into a desired shape by photolithography to form a transparent conductive film 117 and a transparent conductive film 120c constituting the external connection terminal 120. Here, the transparent conductive film 120c is formed to cover the top surface and side surfaces of a multi-layered film 120b. This configuration prevents the side surfaces of the multi-layered film 120b from being exposed, thereby preventing the aluminum film from being corroded.

(10) Forming a Reflective Film

A reflective film 119 is formed by layering a molybdenum film, an aluminum film, and an indium tin oxide film in the reflective display region by sputtering or like method, and by patterning using photolithography.

Subsequently, an alignment film 118 is formed (printed) by offset printing or the like.

Next, the alignment film 118 is rubbed, and a sealing member 119 is formed (printed) on the TFT substrate, and the color filter substrate with a color filter and the like formed thereon and the TFT substrate are bonded together. FIG. 2 shows the configuration in this stage. Materials for the sealing member 119 are not particularly limited, and a ultraviolet curable resin, heat curable resin, or the like can be used. The bonded substrates are individually separated, and a liquid crystal material is introduced into between the substrates and sealed in to form a liquid crystal layer 125 in the region bordered by the sealing member 119. Further, polarizing plates are attached to both substrates.

The color filter substrate can be manufactured by a common method and therefore description of the method is omitted. Here, photo spacers 135 can be formed by patterning by photolithography or like method after a photosensitive resin is applied to the entire surface of the substrate by spin coating or the like. Instead of photo spacers 135, beads dispersed over the substrate surface can also be used.

Alternatively, a liquid crystal material may also be dripped into the region bordered by the sealing member 119 on the TFT substrate after the sealing member 119 is printed. In that case, substrates are bonded and panels are separated after the liquid crystal is introduced by dripping.

Next, after an anisotropic conductive film 165 is attached to FPC 166, which is an external member, external connection terminals 120B and FPC 166 are bonded by thermocompression. Also, after an anisotropic conductive film 165 is attached to COG 167, the external connection terminal 120A and COG 167 are bonded by thermocompression.

### Embodiment 2

FIG. 6 is a schematic cross-sectional view of a liquid crystal display panel according to Embodiment 2, illustrating the terminal region, which is outside the region bordered by the sealing member. In the liquid crystal display panel according to Embodiment 2, the configuration of the pixel region, which is inside the region bordered by the sealing member, and the configuration of the color filter substrate in the terminal region are substantially the same as those of Embodiment 1. Like FIG. 2 of Embodiment 1, FIG. 6 shows the configuration prior to panel separation.

Here, a configuration of the TFT substrate in the terminal region is described. As shown in FIG. 6, in the terminal region, a base layer 211 and a first insulating film 213 are layered in this order over a substrate 210. Over the first insulating film 213, a conductive film 220a is disposed, which was formed by patterning in the same manufacturing step as the gate wiring. Over the conductive film 220a, a multi-layered film 220b is disposed, which was formed by patterning in the same manufacturing step as the source and drain wirings. That is, conductive films 220a and 220b constitute the external connection terminals 220. In the region on the first insulating film 213 where the external connection terminal 220 is not present, a multi-layered interlayer film 215 is disposed. However, portions (edge portions) of the multi-layered interlayer film 215 overlap the edge portions of the external connection terminal 220. Also, a planarizing film 216 is disposed over the multi-layered interlayer film 215. Edges of the multi-layered film 220b constituting the external connection terminal 220 are disposed under the planarizing film 216. Over the planarizing film 216, a transparent conductive film 217 and an alignment film 218 are disposed. Here, the height of the panel-constituting members 222 in the terminal region is substantially the same as the height of the panel-constituting members in the pixel region.

Configuration of the color filter substrate in the terminal region is substantially similar to that of the color filter substrate of a liquid crystal display panel of Embodiment 1. That is, a color filter 231, an overcoat layer 232, a common electrode 233, and an alignment film 234 are disposed in this order over the substrate 230, and photo spacers 235 having a height of 4 μm are disposed on the common electrode 233.

In Embodiment 2, because the height of the panel-constituting members in the regions facing the spacers are made consistent inside and outside the region bordered by the sealing member, display quality can be improved as in the case of Embodiment 1.

Furthermore, in Embodiment 2, the external connection terminal 220 does not include a transparent conductive film. Therefore, contact resistance generated by external connection can be reduced. A multi-layered film 220b is a multi-layered film of titanium/aluminum/titanium. That is, the top and bottom surfaces of the aluminum film, which is prone to corrosion, is covered by titanium films. However, because the titanium films and the aluminum film are etched in the same process, sides of the aluminum film are not covered by the titanium film. In Embodiment 1, sides of the multi-layered film 120b are covered with the transparent conductive film 120c and thereby the aluminum film is prevented from being corroded. In Embodiment 2, on the other hand, the edges of the multi-layered film 220b are placed under the planarizing film 216 to prevent the sides of the aluminum film from being exposed, thereby preventing corrosion of the aluminum film.

### Embodiment 3

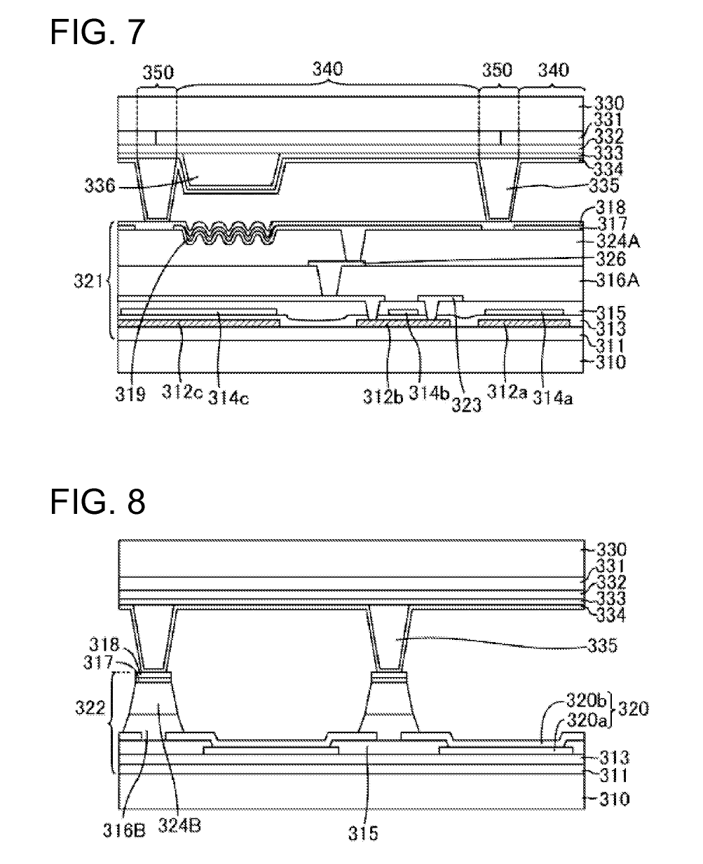

FIG. 7 is a schematic cross-sectional view of a liquid crystal display panel according to Embodiment 3, illustrating the pixel region, which is inside the region bordered by the sealing member. FIG. 8 is a schematic cross-sectional view of a liquid crystal display panel according to Embodiment 3, illustrating the terminal region, which is outside the sealing member. FIGS. 7 and 8 show the configuration before the panel separation, as in the case of FIG. 1 and FIG. 2 of Embodiment 1.

The pixel region of a liquid crystal display panel according to Embodiment 3 is substantially similar to that of the liquid crystal display panels according to Embodiments 1 and 2, except that two layers of planarizing films are provided, and a multi-layered wiring structure is formed by providing a wiring between the two layers of planarizing films. Also, the terminal region, which is outside the region bordered by the sealing member, has a structure that is substantially similar to that of the liquid crystal display panel of Embodiment 2, except that two layers of planarizing films are provided in areas facing the spacers. That is, similar to Embodiment 1, as shown in FIG. 7, in the display region (region bordered by the sealing member) of the TFT substrate of Embodiment 3, a base layer 311, semiconductor layers 312a, 312b, and 312c, a first insulating film 313, a gate wiring 314b, an auxiliary capacitance electrodes 314a and 314c, and a multi-layered interlayer film 315 are disposed over the substrate 310. Source and drain wirings 323 are formed on the multi-layered interlayer film 315, and they are connected to the semiconductor layer 312b via contact holes. On the source and drain wirings 323, a first planarizing film 316A having a thickness of 2.5 μm and a second planarizing film 324A having a thickness of 2.5 μm are provided. Between the first planarizing film 316A and the second planarizing film 324A, a conductive wiring 326 is interposed in which an aluminum film having a thickness of 350 nm and a molybdenum film having a thickness of 50 nm are layered. Over the second planarizing film 324A, a transparent conductive film 317, a reflective film 319, and an alignment film 318 are disposed. The transparent conductive film 317 functions as a pixel electrode in the display region.

Configuration of the color filter substrate in the pixel region is substantially similar to that of the liquid crystal display panel of Embodiments 1 and 2. That is, a color filter 331, an overcoat layer 332, a white color filter 336, a common electrode 333, and an alignment film 334 are disposed over a substrate 330, and photo spacers 335 having a height of 4 μm are disposed in a boundary region 350. The white color filter 336 is disposed in a pixel region 340.

Next, configuration of the TFT substrate in the terminal region is described. Configuration of the TFT substrate in the terminal region is substantially similar to that of the liquid crystal display panel of Embodiment 2, except that the planarizing film is a two-layered film, and a transparent conductive film and an alignment film are disposed on the planarizing film. That is, in the TFT substrate in the terminal region, a base layer 311, a first insulating film 313, a multi-layered interlayer film 315, and an external connection terminal 320 are formed over a substrate 310. The external connection terminal 320 has a multi-layered structure composed of a conductive film 320a, which is formed in the same manufacturing step as the gate wiring 314b, and a multi-layered film 320b, which is formed in the same manufacturing step as the source and drain wirings 323. Edges of the multi-layered film 320b are disposed under the planarizing film 316B, and the sides of the multi-layered film 320b are covered by the planarizing film 316B. A planarizing film 324B is disposed on the planarizing film 316B. Also, a transparent conductive film 317 and an alignment film 318 are disposed over the planarizing film 324B.

Configuration of the color filter substrate in the terminal region is substantially similar to that of the color filter substrate of liquid crystal display panels of Embodiments 1 and 2. That is, a color filter 331, an overcoat layer 332, a common electrode 333, and an alignment film 334 are disposed in this order over the substrate 330, and a photo spacers 335 having a height of 4 μm are arranged on the common electrode 333.

The height of the panel-constituting members 321 of the TFT substrate in the pixel region according to Embodiment 3 is substantially the same as the height 322 of the panel-constituting members in the terminal region. That is, by making the height of the panel-constituting members consistent in the pixel region and in the terminal region, cell thickness irregularities can be suppressed and a liquid crystal display panel of high display quality can be provided.

Also, because a transparent conductive film is not disposed on the external connection terminal 320 in the terminal region, contact resistance can be made low.

Furthermore, because the edges of the multi-layered film 320b of the external connection terminals 320 are disposed under the planarizing film 316B, the external connection terminal 320 can be prevented from being corroded even if the transparent conductive film is not disposed over the multi-layered film 320b.

Also, the conductive film formed in a similar manufacturing step as the conductive wiring 326 is not included in the external connection terminal 320. That is, because a molybdenum film, which has a low water resistance, is not used on the top surface of the external connection terminal 320, reliability of the external connection terminal 320 can be improved.

### COMPARISON EXAMPLE 1

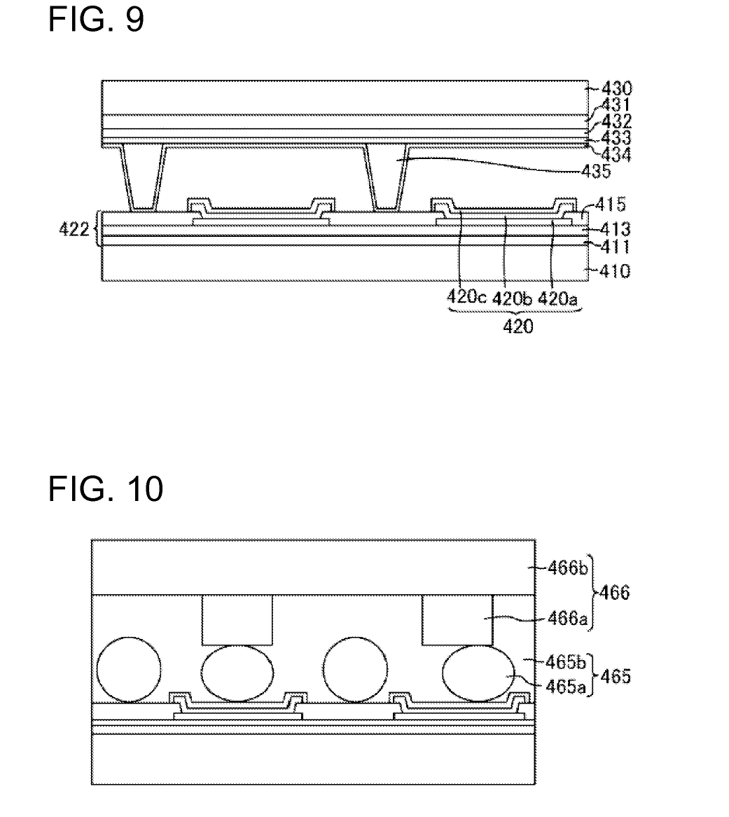

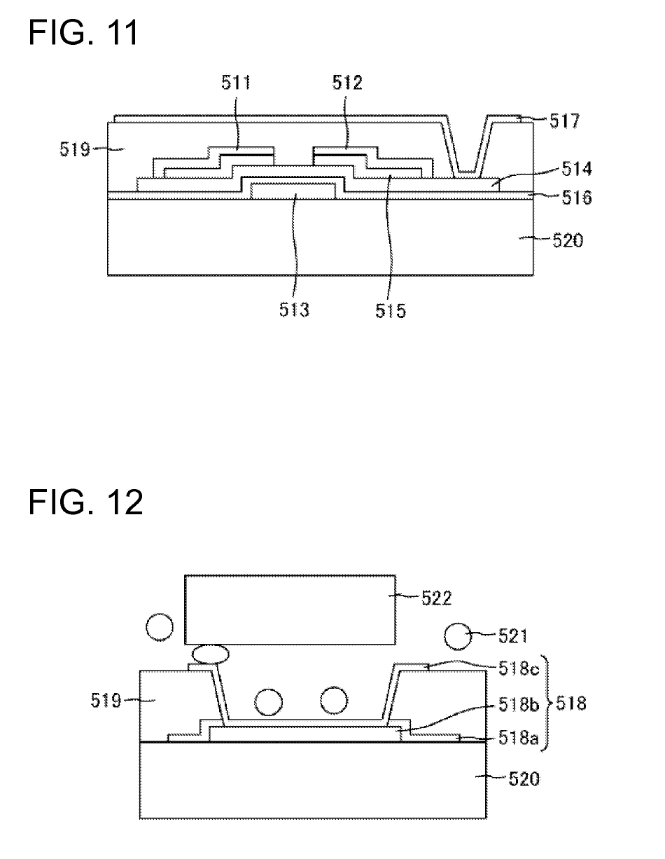

FIG. 9 is a schematic cross-sectional view of a liquid crystal display panel according to Comparison Example 1, illustrating the terminal region, which is outside the region bordered by the sealing member. In FIG. 9, as in FIG. 2 of Embodiment 1, the configuration prior to the panel separation is illustrated.

Configuration of a liquid crystal display panel according to Comparison Example 1 is substantially similar to the configuration of Embodiment 1, except for the following two points: (1) in the terminal region, the region that faces a spacer does not have a multi-layered structure in which the planarizing film 116B, the transparent conductive film 117, and the alignment film 118 are layered, and (2) the distance between the substrates in the terminal region is smaller than the distance between the substrates in the display region. That is, in the TFT substrate in the terminal region, a base layer 411, a first insulating film 413, a multi-layered interlayer film 415, and external connection terminals 420 are formed over a substrate 410. The external connection terminals 420 have a structure in which a conductive film 420a, which is formed in the same manufacturing step as the gate wiring, a multi-layered film 420b, which is formed in the same manufacturing step as the source and drain wirings, and a transparent conductive film 420c, which is formed in the same manufacturing step as the pixel electrode, are disposed.

The configuration of the color filter substrate, which faces the TFT substrate, is substantially similar to that of the color filter substrate of the liquid crystal display panel of Embodiment 1. That is, a color filter 431, an overcoat layer 432, a common electrode 433, and an alignment film 434 are disposed in this order over a substrate 430, and photo spacers 435 having a height of 4 μm are disposed on the common electrode 433.

In Comparison Example 1, in the terminal region, the height of the panel-constituting members 422 in the region that faces the spacer 435 is smaller than the height of those in the display region, because no planarizing film is provided there. When the height of the panel-constituting members in the region overlapping the spacer 435 is significantly different between inside and outside the sealing member, the cell thickness in the pixel region can become irregular, and the display quality can be compromised.

FIG. 10 is a schematic cross-sectional view illustrating a liquid crystal display panel according to Comparison Example 1, illustrating the structures of the external connection terminals and a flexible printed circuit (FPC) in the terminal region of the TFT substrate as they are bonded together by an anisotropic conductive film. As shown in FIG. 10, an external connection wiring 466a of FPC 466 is connected to the external connection terminals via conductive particles 465a in an anisotropic conductive film 465. In this case, if two or more conductive particles 465a are attached to each other, adjacent external connection terminals can be short-circuited (leaked). Here, the external connection wiring 466a is formed on the FPC base material 466b, and conductive particles 465a are dispersed in the insulating material 465b.

The present application claims priority to Patent Application No. 2008-320129 filed in Japan on Dec. 16, 2008 under the Paris Convention and provisions of national law in a designated State. The entire contents of which are hereby incorporated by reference.

### DESCRIPTION OF REFERENCE CHARACTERS

110, 130, 210, 230, 310, 330, 410, 430, 520: substrate

111, 211, 311, 411: base layer

112a, 112b, 112c, 312a, 312b, 312c: semiconductor layer

113, 213, 313, 413: first insulating film (gate insulating film)

114a, 114c, 314a, 314c: auxiliary capacitance electrode

114b, 314b: gate wiring

115, 215, 315, 415: multi-layered interlayer film

116A, 116B, 216: planarizing film

117, 120c, 217, 317, 420c: transparent conductive film

118, 134, 218, 234, 318, 334, 434: alignment film

119, 319: reflective film

120, 120A, 120B, 220, 320, 420: external connection terminal

120a, 220a, 320a, 420a, 518a, 518b, 518c: conductive film

120b, 220b, 320b, 420b: multi-layered film

121, 122, 222, 321, 322, 422: panel-constituting members

123, 323: source and drain wirings

125: liquid crystal layer

131, 231, 331, 431: color filter

132, 232, 332, 432: overcoat layer

133, 233, 333, 433: common electrode

135, 235, 335, 435: photo spacer

136, 336: white color filter

140, 340: pixel region

150, 350: boundary region

160: display region

161: sealing member

162: electronic component

165, 465: anisotropic conductive film

165a, 465a, 521: conductive particle

165b, 465b: insulating material

166, 466: flexible printed substrate

166a, 466a: external connection wiring

166b, 466b: FPC member

167: COG

316A, 316B: first planarizing film

324A, 324B: second planarizing film

326: conductive wiring

511: source electrode

512: drain electrode

513: gate electrode

514: amorphous silicon film

515: ohmic contact layer

516: gate insulating film

560: thin film transistor

517: reflective electrode

518: pad

519: organic insulating film

522: bump

1. A liquid crystal display panel comprising a thin film transistor substrate and an opposite substrate facing said thin film transistor substrate,
wherein said thin film transistor substrate and said opposite substrate are bonded together with a sealing member,
wherein a liquid crystal layer is held inside a region bordered by said sealing member,
wherein spacers are disposed inside and outside the region bordered by said sealing member, and
wherein panel-constituting members of said thin film transistor substrate in regions overlapping said spacers have a thickness that is substantially the same inside and outside the region bordered by said sealing member.

2. The liquid crystal display panel according to claim 1,
wherein said thin film transistor substrate has a structure in which external connection terminals are disposed outside the region bordered by the sealing member and a planarizing film is disposed in regions overlapping the spacers inside and outside the region bordered by the sealing member, and
wherein said planarizing film is removed at least in a part of the region where the external connection terminals are disposed.

3. The liquid crystal display panel according to claim 2, wherein said planarizing film is a film disposed immediately below a pixel electrode.

4. The liquid crystal display panel according to claim 2, wherein edges of said external connection terminals are disposed under said planarizing film.

5. The liquid crystal display panel according to claim 4, wherein said external connection terminals do not include a transparent conductive film.

6. The liquid crystal display panel according to claim 4,
wherein said thin film transistor substrate has a multi-layered wiring structure in which a first conductive film, a first planarizing film, a second conductive film, and a second planarizing film are disposed in this order inside a region bordered by the sealing member, and
wherein said external connection terminals do not include a conductive film formed in a manufacturing step in which the second conductive film is formed.

7. A liquid crystal display device comprising the liquid crystal display panel according to claim 1.
